(19) United States
(12) Patent Application Publication
(10) Pub. No.: US 2014/0179176 A1
(43) Pub. Date: Jun. 26, 2014

(54) JUMPER PIN

(71) Applicants: HONG FU JIN PRECISION INDUSTRY (ShenZhen) CO., LTD., (US); HON HAI PRECISION INDUSTRY CO., LTD., New Taipei (TW)

(72) Inventors: LEI LIU, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., ShenZhen (CN)

(21) Appl. No.: 13/831,871

(22) Filed: Mar. 15, 2013

(30) Foreign Application Priority Data
Dec. 21, 2012 (CN) 201210561180.1

(51) Int. Cl. H01R 13/04

(52) U.S. Cl. CPC H01R 13/04
USPC 439/891

(57) ABSTRACT

A pin for use with a jumper is illustrated. The jumper defines two insertion holes. The pin includes a main rod and at least one engaging portion. The main rod includes an arc-shaped first end, an opposite second end, and a sidewall between the first end and the second end. The at least one engaging portion connected to the main rod and comprising a top end lower than the first end of the main rod, the top end being configured to be inserted into one of the insertion holes of the jumper.

### BACKGROUND

1. Technical Field

The present disclosure relates to a jumper pin.

2. Description of Related Art

Pins and jumpers are often used on a motherboard of a computer. A sharp end of a pin may be soldered to the board, and another sharp end is received in a jumper. While aligning a jumper to push it onto the pin, a user can easily poke their finger on the sharp end. Thus, a new safer pin is needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a pin according to a first embodiment.

FIG. 2 is an isometric view of a pin according to a second embodiment.

FIG. 3 is an isometric view of a pin according to a third embodiment.

FIG. 4 is an isometric, assembled view showing a circuit board on which two rows of pin are mounted and several jumpers have been installed connecting pairs of pins.

FIG. 5 is an exploded, isometric view the circuit board, the pins, and the jumpers of FIG. 4.

### DETAILED DESCRIPTION

Embodiments of the present disclosure are now described in detail, with reference to the accompanying drawings.

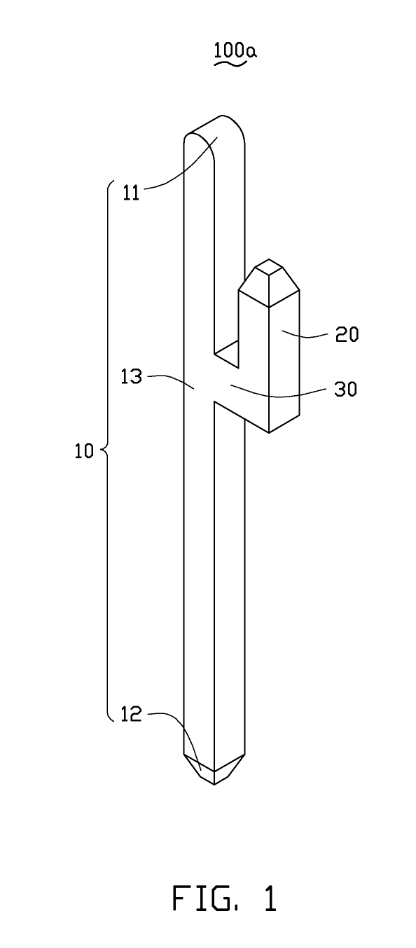

Referring to FIG. 1, a jumper pin 100a, for use with a jumper, includes a main rod 10, an engaging portion 20, and a connecting portion 30 connecting the engaging portion 20 to the main rod 10.

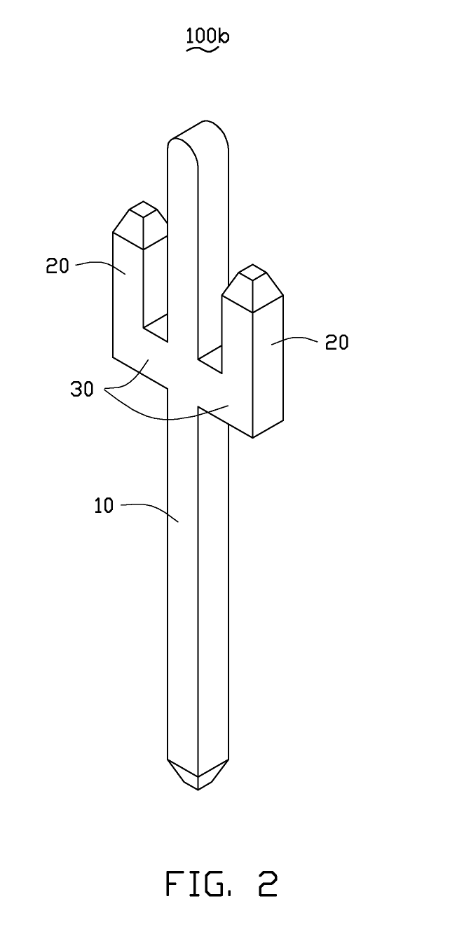

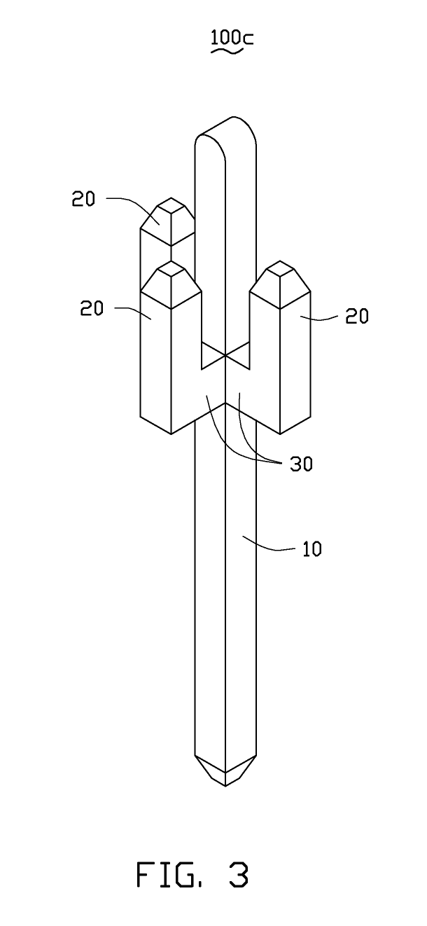

Referring to FIGS. 2-3, the jumper pin 100b includes two engaging portions 20 and two connecting portions 30, and the jumper pin 100c includes three engaging portions 20 and three connecting portions 30.

The main rod 10 includes an arc-shaped first end 11, an opposite second end 12, and a sidewall 13 between the first end 11 and the second end 12. A top end of the engaging portion 20 is lower than the first end 11 of the main rod 10. In the embodiment, the connecting portion 30 is perpendicularly connected to the sidewall 13 and the engaging portion 20.

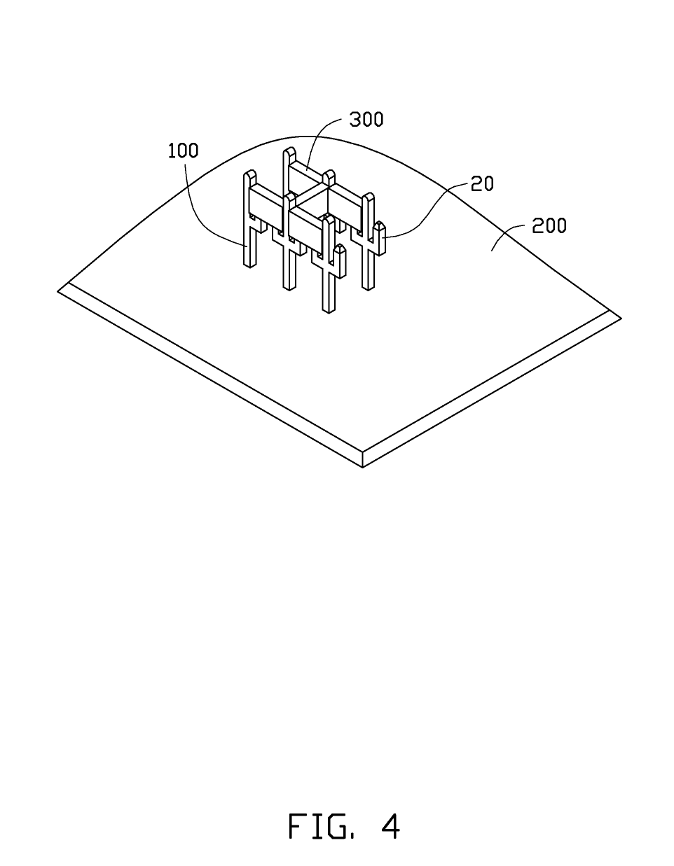

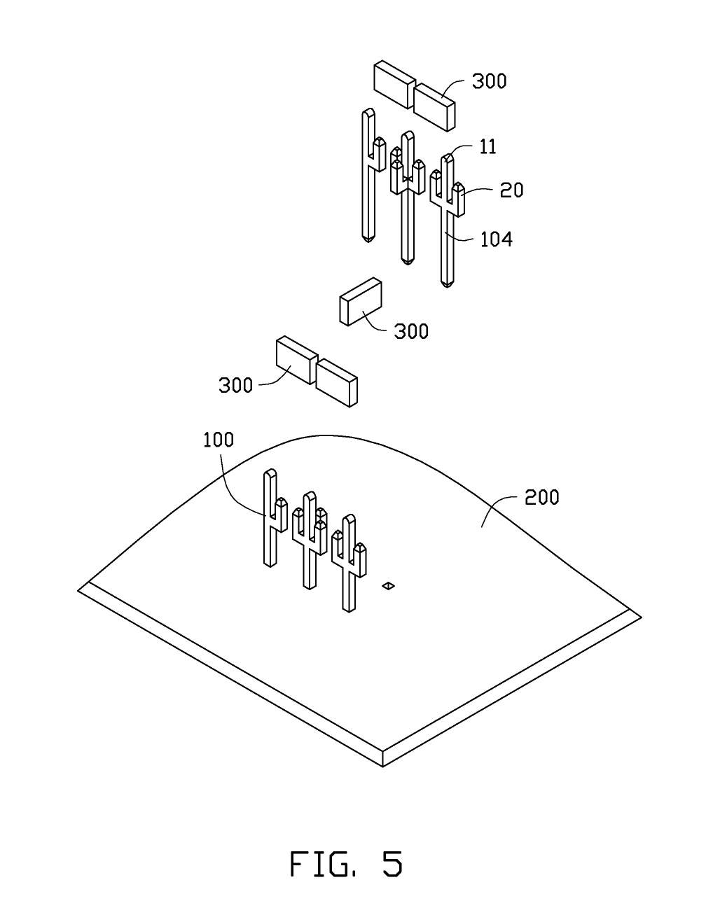

Referring to FIGS. 4-5, one end of the jumper pins 100 is soldered to a circuit board 200, and a number of jumpers 300 are installed to connect each pair of adjacent jumper pins 100. The jumpers 300 each define two insertion holes (not shown) for receiving the top ends of two adjacent engaging portions 20. Thus, the jumpers 300 electrically connect the two adjacent jumper pins 100 together. In the present disclosure, the top end of the engaging portion 20 is lower than the arc-shaped first end 11, thereby preventing the jumper pin 100 from hurting the fingers of the users.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A jumper pin for use with a jumper, the jumper defining two insertion holes, the jumper pin comprising:
a main rod comprising an arc-shaped first end, an opposite second end, and a sidewall between the first end and the second end; and
at least one engaging portion connected to the main rod, the at least one engaging portion comprising a top end lower than the first end of the main rod, the top end being configured to be inserted into one of the insertion holes of the jumper.

2. The jumper pin as described in claim 1, further comprising at least one connecting portion connecting the at least one engaging portion to the sidewall of the main rod.

3. The jumper pin as described in claim 1, wherein the at least one connecting portion is perpendicular to the at least one engaging portion and the sidewall of the main rod.
